(19) United States
(12) Patent Application Publication
(10) Pub. No.: US 2026/0354471 A1
(43) Pub. Date: Nov. 12, 2026

(54) Heating Unit for an Aerosol-Generating Article

(71) Applicant: JT International SA, Geneva (CH)

(72) Inventor: Pier Paolo Monticone, Schwyz (CH)

(73) Assignee: JT International SA, Geneva (CH)

(21) Appl. No.: 19/130,373

(22) PCT Filed: Nov. 21, 2023
(86) PCT No.: PCT/EP2023/082561

§ 371 Date: May 15, 2025

(30) Foreign Application Priority Data
Nov. 25, 2022 (EP) 22209677.8

(51) Int. Cl. A24F 40/46; A24F 40/20

(52) U.S. Cl. CPC A24F 40/46; A24F 40/20

(57) ABSTRACT

A heating unit for an aerosol-generating article includes a heating oven including an oven component, the heating oven configured to be operated in at least a heated mode to heat an aerosol-forming substrate of an aerosol-generating article when received within the heating oven, and a non-heated mode; and an oven holder configured to be heated when the heating oven is operated in the heated mode; wherein the oven holder is configured to form a fixed connection with the oven component when the heating oven is operated in the heated mode, and further configured to release the fixed connection with the oven component when the heating oven is operated in the non-heated mode.

### TECHNICAL FIELD

The present invention relates to a heating unit for an aerosol-generating device. The heating unit comprises a heating oven and an oven holder, the heating oven being configured to be operated in at least a heated mode and a non-heated mode. Depending on the mode of operation a fixed connection between the oven holder and an oven component comprised by the heating oven is formed.

The present invention also relates to a respective aerosol-generating device and system.

### TECHNICAL BACKGROUND

Aerosol-generating devices, in particular Electronic Nicotine Delivery Systems (known as ENDS) have become popular worldwide over the last decades. These devices are alternatives to traditional combustible tobacco products such as cigarettes.

Several types of aerosol-generating devices are currently available on the market, based on varying aerolization technologies and aerosol-generating substrates. A particular subset of aerosol-generating devices is heated tobacco products, also known as “heat-not-burn” products and/or systems (HNB). These HNB systems can generate an inhalable aerosol from heating a tobacco containing substrate, usually in solid or pulverulent form. Such HNB systems require an electronic device comprising a heating unit to heat up a tobacco containing substrate instead of burning tobacco as performed in conventional cigarettes.

The above-mentioned heating unit(s) are usually provided with a heating cavity or oven, wherein an aerosol-generating article (or consumable) comprising tobacco can be inserted. Subsequently, the tobacco of the consumable is heated until an aerosol is formed. The heating oven generates elevated temperatures between about 250 °C to 400 °C, which contributes to a rapid formation of an aerosol that a user can inhale.

Heating ovens require appropriate fixation and sealing means, such that heating ovens do not move and are not displaced during usage and sealing is ensured. Furthermore, means for cleaning and/or replacing the heating ovens when in use should be provided to enable proper functionality during the life cycle of aerosol-generating devices comprising such a heating oven. Moreover, safety is to be ensured such that a user does not get harmed when the aerosol-generating device is in use and/or when cleaning and/or replacing the heating oven.

Conventional implementations of heating ovens in HNB devices fail to tackle these challenges or at least fail to tackle these challenges adequately. As an example, fixation of a heating oven is conventionally performed by a fixing pin protruding through a small orifice at a bottom of the heating oven. The fixing pin is connected to the heating oven with a sealing resin, i.e. an adhesive. Thus, the heating oven is fixed throughout the life cycle of the aerosol-generating device.

Accordingly, such conventional implementations do not allow to remove the heating oven without destruction of the aerosol-generating device. Thus, it is not possible to clean and/or replace the heating oven easily. Furthermore, the process of manufacture and assembly of such conventional heating ovens is subject to cumbersome and extensive steps to provide an appropriate shape of the (bottom of the) heating oven and to place the fixing pin appropriately. Thus, the process of manufacture and assembly of conventional heating ovens is impeded. Automation of such conventional manufacturing may not be easily achieved. Rather, skilled labor is required, and as a consequence, the process is time-consuming and costly.

Therefore, improvements are called for on such heating units comprising a heating oven and aerosol-generating devices comprising these heating units.

Against this background, an object of the present invention is to address one or more or all of the above-mentioned challenges. Particularly, it is an object of the present invention to provide an improved heating unit with a heating oven for an aerosol-generating article. The resulting heating oven will be provided with improved fixing means such that cleaning and/or removal of the heating oven is facilitated. It is a further object that safety of a user is ensured, such that cleaning and/or removal of the heating oven is provided in a safe state. Additionally, it is an object to overcome cumbersome manufacturing steps associated with conventional heating units. Thus, a heating unit will be provided, which can be manufactured and assembled in a simpler way. Furthermore, the manufacture and assembly can be automated more easily than at existing implementations. Accordingly, it is also an object to facilitate an improved, cost-efficient, and fast manufacture of such a heating unit.

These and other objects, which become apparent from the following description, are solved by the subject-matter of the independent claims. Preferred embodiments are subject of the dependent claims.

### SUMMARY OF THE INVENTION

### General Aspects

A 1^{st} embodiment of the invention is directed to a heating unit for an aerosol-generating article, the heating unit comprising: a heating oven comprising an oven component, the heating oven configured to be operated in at least a heated mode to heat an aerosol-forming substrate of an aerosol-generating article when received within the heating oven, and a non-heated mode; an oven holder configured to be heated when the heating oven is operated in the heated mode; wherein the oven holder is configured to form a fixed connection with the oven component when the heating oven is operated in the heated mode, and further configured to release the fixed connection with the oven component when the heating oven is operated in the non-heated mode.

An advantage of this embodiment is that a fixed connection between the oven holder with the oven component may be formed, which may be triggered by the mode of operation of the heating oven. This fixed connection may depend (solely) on physical laws, e.g. it may depend on physical properties of the oven holder and the oven component. This enables a reliable fixation. Further, such a fixation may function independently of complex auxiliary equipment such as electronics and/or sensors, which are cost-intensive and subject to malfunction. Thus, this embodiment increases safety, as failure of fixation due to failure of auxiliary equipment may be obviated.

The oven component may be a part of the heating oven and/or in close communication with the heating oven. Thereby, the heating oven is substantially fixed when the oven component is substantially fixed.

In the heated mode, the heating oven may have a sufficiently elevated temperature, such that an aerosol-forming substrate can be heated. The temperature may be sufficiently high such that an aerosol is formed from the aerosol-forming substrate. Typically, the heated mode comprises the mode of operation when a user inhales such an aerosol and, thus, activates a power source or the like of a device comprising the heating unit.

In the non-heated mode of the heating oven, the heating oven may have a sufficiently low temperature. Usually substantially no aerosol is formed from the aerosol-forming substrate in such a mode. As an example, the temperature of the heating oven may be such that a user does not get hurt if the heating oven is touched in the non-heated mode.

It is appreciated that this embodiment facilitates removal of the heating oven in a safe state, e.g. when the heating oven has a low temperature in the non-heated mode. Thereby, the heating oven may be cleaned and/or replaced easily and in an improved manner. Particularly, if undesired particles, dust and or dirt have/has accumulated around the heating oven, they may be easily removed. Heating units may often be exposed to or subject to environmental impacts such as humidity, dust and/or dirt, which makes the embodiment described herein valuable. Such undesired particles, dust and or dirt could adversely affect the functioning of the heating unit.

Compared to conventional heating units, the heating oven is thus not fixed for substantially the entire life cycle of the heating unit. Costs are reduced by providing a fixing connection depending on a mode of operation.

Another advantage attributable to this embodiment is that the heating oven is fixed when the heating oven has an elevated temperature in the heated mode. This increases safety, as the heating oven is automatically held in place when it is required. Further, this improves heating, as the position of the heating oven does not substantially vary in the heated mode.

The heating unit may be used in an aerosol-generating device to be held by a user. Thus, the aerosol-generating device may be a portable and/or a handheld aerosol-generating device that is comfortable for a user to hold.

The heating unit may be configured to generate an aerosol for being inhaled by a user while a consumable, i.e. an aerosol-generating article is received (at least partially) within the heating oven.

The heating unit may be of a resistive heating type, e.g. comprising a heating element arranged in contact with the heating oven walls to transfer heat thereto by conduction. Resistance heating may also be referred to as joule heating, resistive heating, or Ohmic heating. It means that during operation, when an electrical circuit is established, electrical current passes through a heating element, for example a ceramic heating element. The passage of an electric current through a conductor, such as the heating element, produces heat whose power equals the product of the resistance of the ceramic heating element and the square of the current. Typically, two electrodes provide for an electrical contact to the heating element. The two electrodes ensure that a voltage drop in between the two electrodes is applied and thereby over the heating element, to induce a current. Thereby, the temperature of the heating element may be increased due to the current flow and an electrical resistance of the heating element.

As an example, a heating element may be a thermistor, i.e. a resistor whose resistance depends on the temperature. Further, the heating element may be made of a positive temperature coefficient (PTC) thermistor, such that the resistance of the ceramic heating element increases at higher temperatures. This may provide for a self-regulating effect. In particular, at certain temperatures, the ceramic heating element may not be heated further, because the resistance has increased to such a degree that it prevents further increase of the electrical current.

The heating unit may also be of inductive type, e.g. comprising at least one inductor coil arranged circumferentially about the heating oven and configured to inductively heat a susceptor element contacting the heating oven and/or formed by said heating oven walls. It may also be possible that a susceptor element is arranged in an aerosol-generating article inserted in the heating oven. The heating unit may also be a microwave heating unit comprising the heating oven as a consumable receiving cavity, a microwave radiation source, in particular a solid-state transistor-based microwave source and an impedance matching unit to achieve impedance matching between a consumable article inserted into the heating oven and the microwave field generated from the microwave source. Independent of the type of heating of the heating unit, the fixed connection and releasing of the fixed connection is facilitated.

Advantageously, no means for measuring a temperature are required for forming the fixed connection and for releasing the fixed connection. Furthermore, no controllers, control logic and/or active means, such as active locking mechanisms, retaining elements that are movable and/or active mechanical movements of parts in general are required. It is to be noted that forming a fixed connection as described herein may not be understood as forming a fixed connection with an aerosol-generating article (which is received in the heating oven).

The heating oven as referred to herein is to be understood as a three-dimensional space that is heated in the heated mode, preferably by heating the heating oven's walls. Exemplarily, by way of the three-dimensional space of the heating oven, an elongate heating element protruding or extending into a space is not to be regarded as a heating oven.

According to a 2^{nd} embodiment, the oven holder is configured to be clamped at least partially into the oven component to form the fixed connection, and further configured to not be clamped into the oven component for releasing the fixed connection.

To “be clamped at least partially” into the oven component means that the oven holder may extend, expand and/or protrude into the oven component such that a fixed connection, e.g. a fastening, attaching, and/or rigid connection between the oven holder and the oven component is formed. Said fixed connection is released when the heating unit is operating in the non-heated mode. In such a mode, the oven holder is not clamped into the oven component. By way of the clamping and/or the fixed connection, also a sealing of the heating oven can be ensured.

The phrase “to not be clamped into the oven component” means that the heating oven may be removed without requiring excessive forces by a user. In some instances, it is possible, that there is at least partially a contact between the oven holder and oven component, even if the oven holder is not clamped into the oven component. However, this may not necessarily increase forces required for removal of the heating oven by a user.

This embodiment has the advantage that the manufacturing of the heating unit can be improved. The fixing may be established solely by clamping the oven holder at least partially into the oven component. This does not necessitate cumbersome connection means. Rather, it could be established by cylindrical sections that interact with each other. Thus, manufacturing can be accelerated and errors during manufacturing can be eliminated.

### Temperature Dependent Fixing, Elastic Deformation

According to a 3^{rd} embodiment, the oven component comprises a first material and the oven holder comprises a second material, wherein the thermal expansion of the second material is greater than the thermal expansion of the first material.

This embodiment facilitates a different thermal expansion of the oven component and the oven holder. By way of the thermal expansion, the oven holder may be in a state of being clamped at least partially into the oven component or of not being clamped at least partially into the oven component. Accordingly, fixing, and non-fixing of the heating component and the heating oven may depend on the temperature of the oven component and the oven holder.

A greater thermal expansion means that the expansion, at a (certain) temperature and/or a (certain) temperature region, is greater. This embodiment facilitates that the oven holder expands by a greater extent than the oven component. Thereby the oven holder may be clamped at least partially into the oven component in the heated mode.

It is appreciated that triggering of the fixed connection and releasing the fixed connection occurs by the physics underlying the materials according to the 2^{nd} embodiment. This has the advantage that fixing can be performed in a reliable, predictable, cost-effective, and reproduceable manner.

According to a 4^{th} embodiment, the thermal expansion of the first material is within the elastic deformation range of the first material and/or the thermal expansion of the second material is within the elastic deformation range of the second material.

Deformation refers to the change in size or shape of an object. The elastic deformation range as used herein may be understood as follows: strain is the relative change in size, length and/or shape of an object and can be expressed as a non-dimensional change in length. Strains are related to the forces acting on the object. The forces can be expressed by a stress (force per surface area of the object).

The relationship of stress (y-axis) and strain (x-axis) can be visualized by a stress-strain curve. This relationship, i.e. the shape of this curve, is dependent on properties of the material of the object. The relationship between stress and strain is generally linear and reversible up until a yield point. Such a range of the stress-strain curve may be referred to as the elastic deformation range.

The elastic deformation range is different from the plastic deformation range. The plastic deformation range is characterized by a permanent deformation that remains when stress is reduced. The maximum strain of the elastic deformation may depend on the material.

The 4^{th} embodiment is advantageous as it allows that the thermal expansion of the first material (i.e. of the oven component) and of the second material (i.e. of the oven holder) be repeated multiple times, without any plastic deformation of the oven component and the oven holder. Thus, a reliable fixed connection and release of the fixed connection is ensured.

According to an example, the thermal expansion of the first material is not within the plastic deformation range of the first material and/or the thermal expansion of the second material is not within the plastic deformation range of the second material.

According to a 5^{th} embodiment, in any one of the 3^{rd} or 4^{th} embodiments, the first material has a thermal expansion coefficient of at most 15.0 μm/(m K), preferably at most 13.0 μm/(m K), more preferably at most 11.0 μm/(m K), most preferably at most 9.5 μm/(m K) and/or of at least 6.0 μm/(m K), preferably at least 7.0 μm/(m K), more preferably at least 8.0 μm/(m K), most preferably at least 9.0 μm/(m K); and/or the second material has a thermal expansion coefficient of at least 15.0 μm/(m K), preferably at least 17.0 μm/(m K), more preferably at least 20.0 μm/(m K), most preferably at least 23.0 μm/(m K) and/or of at most 30.0 μm/(m K), preferably at most 27.0 μm/(m K), more preferably at most 25.0 μm/(m K), most preferably at most 23.0 μm/(m K).

The relative expansion (also called strain) of a material divided by the change in temperature may be termed the material's coefficient of thermal expansion. The coefficient of thermal expansion describes how the size of an object changes with a change in temperature.

This embodiment has the advantage that the thermal expansion coefficient of the first material is lower than the one of the second material. Thus, the second material, i.e. the oven holder expands by a greater extent than the first material, i.e. the oven component.

The length of a component (d₁) with an initial length (d₀) may be determined according to the following equation.

$${d}_{1} = {d}_{0} \cdot ( Δ T \cdot α + 1 ) \qquad ( 1 )$$

In the above equation, the thermal expansion coefficient is expressed as a, and the component is subjected to a change of temperature ΔT.

This embodiment allows to select materials of certain thermal expansion coefficients as well as initial sizes of the oven holder and oven component, such that the temperature of the components can be predicted at which the fixed connection is released. Thus, the temperature for removal of the oven holder (e.g. for cleaning) can be determined. This temperature can be predicted upfront, e.g. already before manufacturing. It may also be possible to calibrate such a temperature for removal of the heating oven. For instance, heating units can be provided with different temperatures for removal of the heating oven. As understood, this also comprises heating units with correspondingly different temperature for forming a fixed connection.

According to a 6^{th} embodiment, in any one of the 3^{rd} to 5^{th} embodiments, the first material is steel, such as stainless steel, and/or the second material is aluminum.

These materials are relatively inexpensive and easy to procure. In this embodiment, the materials are limited to steel and/or aluminum. However, in general any combination of materials with different thermal expansion coefficients may be applicable. Importantly, the expansion should be elastic, such that substantially no cracking of the materials occurs.

Ceramics have different thermal expansion coefficients than metals. Accordingly, in one example, the use of ceramics may be possible if they are not found to be too rigid.

According to a 7^{th} embodiment, in any one of the 3^{rd} to 6^{th} embodiments, when the heating oven is operated in the heated mode, the first material and/or the second material have a temperature of at least 40 °C, preferably at least 45 °C, more preferably at least 50 °C, even more preferably at least 55 °C, most preferably at least 60 °C, where an ambient temperature is 25 °C.

With this embodiment, the oven holder and the oven component may form a fixed connection at a temperature of e.g. 40 °C or 60 °C. It is appreciated that at such elevated temperatures a user cannot easily remove the heating oven anymore, which increases safety. It may still be possible to remove the heating oven forcibly, e.g. with an increased force. This, however, would damage the heating oven and/or the oven holder, which is not desired. This embodiment also promotes heating efficiency and comfort for the user, as the fixed connection ensures that heating of an aerosol-generating article is improved, and a fast generation of aerosols can be expected.

It is noted that the ambient temperature could also be about at least 15 °C or 20 °C and at most about 30 °C. The specification of the ambient temperature should support the understanding that the temperature of the first and/or the second material originates from the heating oven and not from the environment.

According to an 8^{th} embodiment, in any one of the 3^{rd} to 7^{th} embodiments, when the heating oven is operated in the non-heated mode, the first material and/or the second material have a temperature of at most 60 °C, preferably at most 55 °C, more preferably at most 50 °C, even more preferably at most 45 °C, most preferably at most 40 °C, where an ambient temperature is 25 °C.

With this embodiment, the fixed connection formed between the oven holder and the oven component may be released at a temperature of e.g. 60 °C or 40 °C. It is appreciated that at such low temperatures a user can easily remove the heating oven. This facilitates cleaning at a safe temperature, without jeopardizing user convenience.

With regard to the ambient temperature, the same rational as described with respect to the previous embodiment applies.

It should be understood that the increase of components' sizes by way of the thermal expansion may be subject to a (small) time delay. Typically, the (small) time delay is negligible, as the material expands substantially simultaneously with the temperature of the material. However, material impurities may not be completely ruled out. Accordingly, once the oven holder reaches a temperature of, e.g. 60 °C, a small time period may be required such that the expansion of the oven holder is sufficient to be at least partially clamped into the oven component (which expands as well at such a temperature of, e.g. 60 °C).

According to a 9^{th} embodiment, in any one of the preceding embodiments, when the heating oven is operated in the non-heated mode, a gap is formed between the surface or surfaces of the oven component and the surface or surfaces of the oven holder which form the fixed connection when the heating oven is operated in the heated mode.

The oven component may have one or more surfaces as described herein. Also, the oven holder may have one or more surfaces as described herein. A gap is formed between these surface(s) in the non-heated mode. The gap has the advantage that removal of the heating oven is enabled.

The surface(s) form the fixed connection. This may be understood in such a way that the surface(s) of the oven component are in contact with the surface(s) of the oven holder. In an example, the surface(s) of the oven component may be opposite to, facing and or surrounding the surface(s) of the oven holder.

According to a 10^{th} embodiment, in the preceding embodiment, the gap is on average 0.001 mm, preferably at least 0.002 mm, more preferably at least 0.004 mm, even more preferably at least 0.006 mm, most preferably at least 0.01 mm and/or at most 0.5 mm, preferably at most 0.2 mm, more preferably at most 0.1 mm, even more preferably at most 0.05 mm, most preferably at most 0.01 mm.

The gap should be sufficiently large to facilitate a relatively easy and convenient removal of the heating oven by a user. A large gap may also be advantageous for the manufacturing process, as manufacturing inaccuracies are tolerated to a greater extent. In addition, a large gap provides for an improved installation space. In some examples, the gap may define a tapered shape or a funnel shape, which can facilitate insertion of the heating oven. On the other hand, the gap should not be too large; otherwise the heat expansion for forming a fixed connection would be required to be too large. This could be disadvantageous, as the materials could undergo plastic deformation. A large gap could also entail that the temperature for the heated mode is too large and that the overall device is not compact. Accordingly, a balance should be struck for the gap.

The gap may be understood as a clearance and provides for a “slip fit” or “sliding fit”, which facilitates removal as compared to a “press fit” or “interference fit”. It is to be noted that the gap sizes also depend on geometry, choice of materials and the threshold temperature for forming the fixed connection.

In case the surface(s) of the oven holder and the surface(s) of the oven component between which the gap is formed are substantially cylindrical, the gap may be substantially equal along a circumferential direction.

When in the heated mode, the gap may be filled with the oven holder by at least 98%, preferably at least 99%, more preferably at least 99.5%, most preferably the gap is completely filled such that a pressure force is provided between an outer surface of the oven holder and the (inner) surface of the oven component. Thereby, the oven holder is at least partially clamped into the oven component.

According to an 11^{th} embodiment, any one of the preceding embodiments further comprises a tube which houses the heating oven, wherein, when the heating oven is operated in the heated mode, a pressure force is provided between the heating oven and the tube.

The tube has the advantage that it can encompass and protect the heating oven from surroundings. In one example, the fixed connection in the heated mode may comprise that the heating oven is pressed against the tube to enhance fixing. This could be achieved by appropriate material selection of the tube.

Generally, sufficient fixing is already achieved by the oven holder being clamped at least partially into the oven component.

As an example, the tube has a substantially cylindrical shape. Furthermore, the heating oven may also have a substantially cylindrical shape. In the non-heated mode, there may be a tube-gap between the heating oven and the tube. The tube-gap may be measured in a radial direction. Furthermore, the tube-gap may be constant along the circumferential direction. In other cases, it may not be constant along the circumferential direction, e.g. the tube-gap may not be circumferentially symmetrical or substantially non-symmetrical.

### Bottom Part of the Heating Oven, Improved Connection

According to a 12^{th} embodiment, in any one of the preceding embodiments, the heating oven is substantially hollow and/or substantially symmetrical.

In this embodiment, the heating oven has a simplified structure, which eases the manufacturing process. It is particularly appreciated that such a simplified structure may also enable to automate the manufacturing process, which reduces production costs. In addition, errors during manufacturing can thus be reduced. Overall, a more reliable heating oven can be provided.

As an example, the heating oven may be manufactured by an extrusion process, followed by an optional cutting such that a desired length of the heating oven is reached.

According to a 13^{th} embodiment, in any one of the preceding embodiments, the oven holder extends into the oven component by at least 5%, preferably at least 10%, more preferably at least 15%, most preferably at least 20% and/or at most 35%, preferably at most 30%, more preferably at most 25%, most preferably at most 20%, of the length of the heating oven.

According to an example, in any one of the preceding embodiments, the oven holder extends into the oven component by at least 0.1 mm, preferably at least 0.2 mm, more preferably at least 0.5 mm, more preferably at least 1.0 mm, more preferably at least 2.0 mm, most preferably at least 3.0 mm and/or at most 15 mm, preferably at most 12 mm, more preferably at most 10 mm, more preferably at most 8 mm, more preferably at most 6 mm, most preferably at most 5 mm.

With the above embodiment and the above example, the extension of the oven holder into the oven component should not be too small and not be too large.

A large extension increases a contact area of the surface(s) of the oven holder and the oven component. Accordingly, forming the fixed connection is improved. However, the extension should not be too large, to avoid wasting space. A small amount promotes a compact device. Accordingly, a balance should be struck for the extension.

In one example, the heating oven may have a length of about 20 mm.

According to a 14^{th} embodiment, in any one of the preceding embodiments, the oven component is arranged at a back end of the heating oven, located opposite a front end of the heating oven through which an aerosol-generating article can be received, wherein the oven holder optionally extends into an end of the oven component located opposite the front end of the heating oven.

By arranging the oven component at a back end of the heating oven, the oven component is usually not be visible for a user operating a device comprising the heating unit. This supports user convenience.

The oven holder may also be located at such a back end of the heating oven, and it may extend into the end of the oven component, which is opposite the front end of the heating oven. Thereby, the oven holder extends into the direction of removal of the heating oven. This has the advantage that the oven component and the oven holder are substantially housed within the device and may not be subject to dust and/or dirt, which could impair their functioning. In addition, substantially no undesired particles may be accumulated between the surface(s) of the oven holder and the oven component forming the fixed connection.

According to a 15^{th} embodiment, in any one of the preceding embodiments, the oven component comprises a slit at a back end of the heating oven facing away from a front end of the heating oven at which an aerosol-generating article can be received.

The slit may be understood as a recess and/or a cut. It increases the elasticity of the oven component, which improves forming a fixed connection. In a preferred example, the slit is arranged vertically, seen when the heating unit stands on a ground. Vertical means that the slit is arranged along a longitudinal axis of the heating oven. The slit could have a length of about 0.05 mm to about 5 mm, depending on the desired elasticity. It is advantageous that the slit is arranged at the bottom of the oven component, as this eases the manufacturing process.

It may also be possible to provide two slits, e.g. on two diametrical sides, preferably on two diametrically opposite sides of the oven component.

According to a 16^{th} embodiment, in any one of the preceding embodiments, the oven component is integrally formed with a cylinder comprised by the heating oven for receiving the aerosol-generating article.

This embodiment facilitates an improved manufacturing process. In one example, the oven component is substantially one piece with the heating oven. However, the oven component may also be a separate piece but in communication (e.g. thermal communication and/or in direct contact) with the heating oven. Importantly, the oven component is integrally formed with the cylinder, such that it can be easily inserted into the tube and/or the device that comprises the heating unit.

According to a 17^{th} embodiment, in any one of the preceding embodiments, the oven component is not fixed to the oven holder by means of an adhesive.

Adhesives have the disadvantage that they could be prone to failure, e.g. if a temperature becomes too high. Further, dispensing with adhesives is advantageous as the fixed connection is not fixed throughout all times.

According to a further embodiment of the heating unit, a cross-section of a part of the oven holder, which is clamped at least partially into the oven component when in the heated mode, is at least 80%, preferably at least 90%, most preferably at least 95% of a cross-section of the oven component when in the non-heated mode.

This facilitates that a fixed connection can be formed by way of thermal expansion.

The cross-section of the part of the oven holder and/or the oven component may be viewed for instance substantially perpendicular to a longitudinal axis of the heating oven. Typically, the longitudinal axis may be arranged substantially parallel to the direction of insertion of an aerosol-generating article into the heating oven.

According to a further embodiment of the heating unit, the oven holder extends out of the oven component at an end of the heating oven opposite the end at which an aerosol-generating article can be received.

This has the advantage that the oven holder can be more easily fixed to remaining parts of the device (e.g. a frame).

### Aerosol-Generating Device

An 18^{th} embodiment of the invention is directed to aerosol-generating device comprising: a heating unit according to any one of the 1^{st} to 17^{th} embodiments; and a power supply configured to provide a current to the heating unit for generating an aerosol to be inhaled by a user.

The aerosol-generating device may be a portable or handheld aerosol-generating device that is comfortable for a user to hold. For instance, the aerosol-generating device may be held between the fingers and/or in the palm of a single hand.

A power supply may be any suitable power supply, for example a DC voltage source, such as a battery, e.g. a lithium iron phosphate battery. Alternatively, the power supply may be a Nickel cadmium battery, a Nickel-metal hydride battery, or a Lithium based battery, for example a Lithium-Cobalt, a Lithium-Iron-Phosphate, Lithium Titanate, or a Lithium-Polymer battery. The power supply may be located within a part of the aerosol-generating device, or it may be another form of charge storage device such as a capacitor. The power supply may allow for recharging and may have a capacity that allows for storing enough energy for one or more, preferably a multitude of ordinary use cycles of the aerosol-generating device.

According to a 19^{th} embodiment, in the aerosol-generating device according to the preceding embodiment, the oven holder is fixed to a part of the aerosol-generating device, such as a frame or housing, preferably within the aerosol-generating device.

The oven holder may be fixed to a part of the aerosol-generating device which is not comprised by the heating oven. As an example, the oven holder may be fixed by way of a screw or the like. Thus, the oven holder may be substantially fixed throughout the lifecycle of the device. Advantageously the fixed connection to the oven component is dependent on the temperature as described herein. Thus, when a fixed connection of the oven holder and the oven component is formed, all components are substantially fixed and do not move within the device, which improves heating of the aerosol-generating article.

According to a 20^{th} embodiment, in the aerosol-generating device according to the 18^{th} or 19^{th} embodiment, the aerosol-generating device comprises a magnet, configured to substantially maintain a position of the heating oven, when the heating oven is operated in the non-heated mode, wherein the magnet is optionally arranged in proximity of a back end of the heating oven, located opposite a front end of the heating oven through which an aerosol-generating article can be received.

The magnet may facilitate that the oven component and/or the heating oven are held in place when the heating oven is in the non-heated mode. Despite the magnet, a convenient removal by the user is still possible when the heating oven is in the heated mode.

“To substantially maintain” means that the forces provided by the magnet are sufficient to prevent substantial movements, but that a user could still remove the heating oven without excessive effort.

A 21^{st} embodiment of the invention is directed to an aerosol-generating system comprising the aerosol-generating device as described herein and an aerosol-generating article comprising an aerosol-forming substrate.

It is noted that the aerosol-generating system and/or aerosol-generating device as described herein may include all aspects and/or embodiments described herein, even if not expressly described as belonging to the aerosol-generating system and/or the aerosol-generating device but rather with reference to the heating unit. It is also to be understood that the features and advantages described with reference to the aerosol-generating system and/or aerosol-generating device may equally be applicable to the heating unit.

### BRIEF DESCRIPTION OF THE FIGURES

In the following, preferred embodiments are described, by way of example only. Reference is made to the following accompanying figures:

FIG. 1 illustrates a heating unit for an aerosol-generating article according to an embodiment of the invention in a side cross-sectional view;

FIG. 2 illustrates a heating unit for an aerosol-generating article according to the embodiment of FIG. 1 of the invention in a non-heated mode of the heating oven, in a side cross-sectional view;

FIG. 2a illustrates a heating unit for an aerosol-generating article according to the embodiment of FIG. 1 of the invention in an operating mode of the heating oven between the non-heated mode and the heated mode, in a side cross-sectional view;

FIG. 2b illustrates a heating unit for an aerosol-generating article according to the embodiment of FIG. 1 of the invention in a heated mode of the heating oven, in a side cross-sectional view;

FIG. 3 illustrates a thermal expansion of an oven component and an oven holder in the non-heated mode of the heating oven (left) and the heated mode of the heating oven (right) according to the embodiment of FIG. 1 of the invention, in a side cross-sectional view;

FIG. 4 illustrates an oven component comprising a slit according to an embodiment of the invention, in a first side cross-sectional view;

FIG. 4a illustrates the embodiment of FIG. 4 in a second side cross sectional view that is 180° rotated compared to the first side cross-sectional view;

FIG. 5 illustrates a schematic diagram of a stress-strain curve; and

FIG. 6 illustrates an aerosol-generating device and an aerosol-generating system according to an embodiment of the invention.

### DETAILED DESCRIPTION OF PREFERRED EMBODIMENTS

### Definitions

The terms “fixing”, “fixation”, “fixed connection” as used herein may be understood such that a relative position of the parts that are fixed does not substantially vary.

The term “aerosol-generating article” as used herein may also be referred to as a consumable or consumable article. Such an aerosol-generating article may comprise an aerosol-forming substrate, which can be heated to generate an aerosol and/or an inhalable vapor for the user.

The terms “one end”, “the other end”, “outer side”, “upper”, “above”, “inner side”, “under”, “below”, “horizontal”, “coaxial”, “central”, “end” “part”, “length”, “outer end” etc., which indicate the orientation or positional relationship, are based on the orientation or positional relationship shown in the drawings.

The terms “upper”, “above”, “below”, “under” and the like as used in the present invention to indicate a relative position in space are used for the purpose of facilitating explanation to describe a unit, device, part, component and/or feature shown in the drawings relative to the relationship of another unit, device, part, component and/or feature.

The term of the relative position in space may be intended to include different orientations of the unit, device, part, component and/or feature other than those shown in the figures. For example, if the unit, device, part, component and/or feature in the figure is turned over, the unit, device, part, component and/or feature described as being “below” or “under” other units, devices, parts, components and/or features will be “above” the other unit, device, part, component and/or feature. Therefore, the exemplary term “below” can encompass both the above and below orientations.

### Embodiments Shown in the Figures

In the following, the invention is described with reference to the accompanying figures in more detail. However, the present invention can also be used in other embodiments not explicitly disclosed hereafter. As detailed below, the embodiments are compatible with each other, and individual features of one embodiment may also be applied to another embodiment.

Throughout the figures and description, the same reference numerals refer to the same elements, unless stated otherwise. The figures may not be drawn to scale, and the relative size, proportions, and depiction of elements in the figures may be exaggerated for the purpose of clarity, illustration, and convenience. The figures do not limit the scope of the claims but merely support the understanding of the invention.

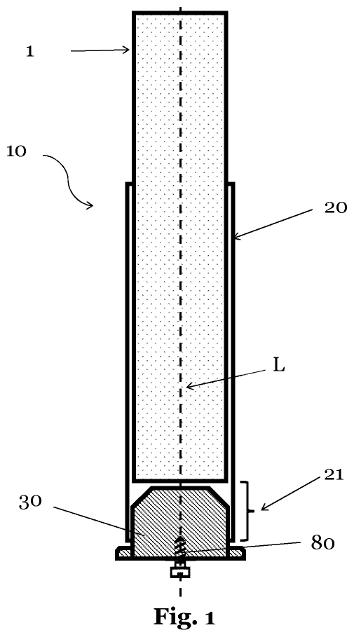

FIG. 1 shows a heating unit 10 for an aerosol-generating article 1 according to an embodiment of the invention in a side cross-sectional view. The heating unit 10 comprises a heating oven 20, which comprises an oven component 21. The heating oven 20 is configured to be operated in at least a heated mode to heat an aerosol-forming substrate of the aerosol-generating article 1 when received within the heating oven 20. The heating oven 20 is further configured to be operated in at least a non-heated mode. This could be the mode in which an aerosol-generating device comprising the heat unit 10 is not in used, e.g. when it is stored somewhere.

It can be seen that the oven component 21 is integrally formed with a cylinder comprised by the heating oven 20 for receiving the aerosol-generating article 1. In this example, the oven component 21 is an integral part of the heating oven 20. However, this does not need to be the case according to the present disclosure. The oven component 21 is indicated by way of a curly bracket in this figure. This means that the length along the longitudinal axis L of the heating oven 20 encompassed by the curly bracket represents the oven component 21.

The heating unit further comprises an oven holder 30 configured to be heated when the heating oven 20 is operated in the heated mode. The oven holder 30 is configured to form a fixed connection with the oven component 21 when the heating oven 20 is operated in the heated mode, and further configured to release the fixed connection with the oven component 21 when the heating oven 20 is operated in the non-heated mode.

The oven holder 30 may be configured to be clamped at least partially into the oven component 21 when the heating oven 20 is operated in the heated mode. Moreover, the oven holder 30 may be configured to not be clamped into the oven component 21 when the heating oven 20 is operated in the non-heated mode.

The oven component 21 comprises a first material (not separately indicated; reference numeral 21 may represent the first material), and the oven holder 30 comprises a second material (not separately indicated; reference numeral 30 may represent the second material). The thermal expansion of the second material, i.e. of the oven holder 30, is greater than the thermal expansion of the first material, i.e. of the oven component 21. It is appreciated that, in particular if the oven component 21 is integrally formed with the heating oven 20, the heating oven 20 may comprise or consist of the same first material as the oven component 21, as this simplifies manufacturing. Furthermore, the heating oven 20 is substantially hollow and/or substantially symmetrical, which additionally simplifies manufacturing.

In this particular example, the first material (oven component 21) is stainless steel, which has a thermal expansion coefficient of about 9.4 μm/(m K). The second material (oven holder 30) is an aluminum alloy which has a thermal expansion coefficient of about 23 μm/(m K). However, any combination of thermal expansion coefficients of the first and the second material is possible, as long as the thermal expansion of the second material is greater than the thermal expansion of the first material.

The mode of operation of the heating oven 20 in this figure is the non-heated mode, or at least not the heated mode. This is shown by a gap (see reference numeral 35 of the remaining figures) between the oven component 21 and the oven holder 30.

Accordingly, in the mode of operation of this figure, the heating oven 20 may be easily removed for cleaning and/or maintenance. The gap exists between surfaces that form the fixed connection when the heating oven 20 is operated in the heated mode.

Since the heating oven 20 is operated in the non-heated mode, the first material and/or the second material have a temperature of at most 60 °C, preferably at most 55 °C, more preferably at most 50 °C, even more preferably at most 45 °C, most preferably at most 40 °C. The ambient temperature is 25 °C. The heating oven 20 and the oven component 21 are thermally in contact with each other. Thus, the temperature of the heating oven 20 may be similar to the temperature of the oven component 21. It may be possible that their temperatures are the same. Accordingly, a user does not get hurt when the heating oven 20 is removed and touched by hand.

The oven holder 30 extends into the oven component 21 preferably by at least 5% and at most 35% of the length of the heating oven 20. The length of the heating oven 20 is measured along the longitudinal axis L of the heating oven 20 indicated in this figure.

The heating oven may be about 20 mm long (this includes the length of the oven component 21). The preferred extension of the oven holder 30 into the oven component 21 is about 5 mm, which corresponds to 25% of the length of the heating oven 20.

The figure also shows that the oven component 21 is arranged at a back end of the heating oven 20, located opposite a front end of the heating oven 20 through which the aerosol-generating article 1 is received. Furthermore, the oven holder 30 extends into an end of the oven component 21 located opposite the front end of the heating oven 20.

The front end of the heating oven 20 is in a top region of this figure, and its opposite end is at a bottom region of the figure. Similarly, the front end of the heating oven 20 is in a top region of this figure, and the back end of the heating oven 20 is located at a bottom region of this figure.

The heating oven 20, the oven component 21 and/or the oven holder 30 are not fixed to one another by means of an adhesive.

The oven holder 30 is fixed to a part of an aerosol-generating device, such as a frame or housing, preferably within the aerosol-generating device. This is indicated in this figure by screw 80. It could be advantageous that the oven holder 30 extends out of the oven component 21 at an end of the heating oven 20 opposite the end at which the aerosol-generating article 1 is received (i.e. such that the oven holder 30 extends out of the bottom end of the heating oven 20 in this figure). This could facilitate that the oven holder 30 is fixed to a part of the aerosol-generating device.

The aerosol-generating device comprising the heating unit 10 can comprise a magnet (not indicated in this figure), which is arranged in proximity of the back end of the heating oven 20 (the back end of the heating oven 20 is located at a bottom region of this figure).

In the embodiment of this figure the heating oven 20, oven component 21 and/or oven holder 30 can have (a) circular cross-section(s). The cross-section is substantially perpendicular to the longitudinal axis of the heating oven 20. Such longitudinal axis (indicated in this figure as a dashed line L) is arranged substantially parallel to the direction of insertion of an aerosol-generating article 1 into the heating oven 20.

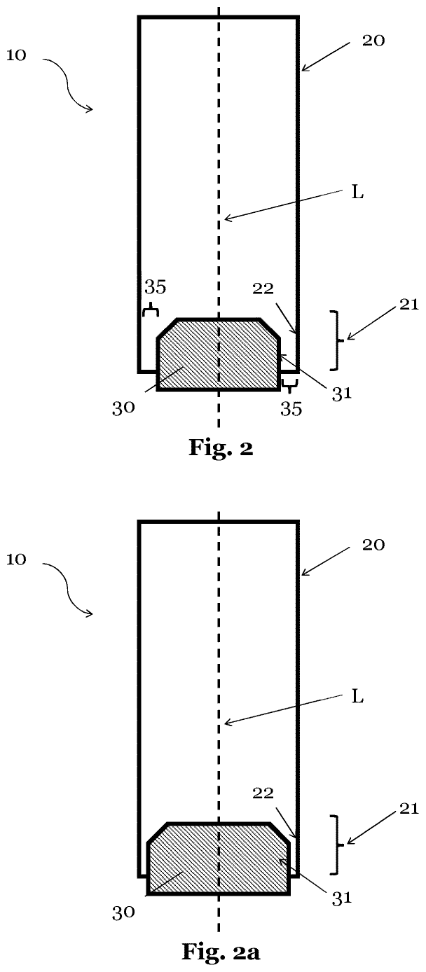

FIG. 2 shows a heating unit 10 for an aerosol-generating article 1 according to the embodiment of FIG. 1 of the invention in a non-heated mode of the heating oven 20, in a side cross-sectional view. In this figure, some features shown in FIG. 1 have been left out for the purpose of clarity and without limiting the scope of protection.

Since the embodiment is shown in the non-heated mode, the first material and/or the second material have a temperature of at most 60 °C, or at most 40 °C as described herein.

A gap 35 is formed between the surface or surfaces 22 of the oven component 21 and the surface or surfaces 31 of the oven holder 30 which form the fixed connection when the heating oven 20 is operated in the heated mode. The gap 35 in this figure is about 0.001 mm to about 0.1 mm as described herein.

The temperatures of the first and/or second material may be sufficiently low, such that there is substantially no thermal expansion compared to an ambient temperature.

FIG. 2a shows a heating unit 10 for an aerosol-generating article 1 according to the embodiment of FIG. 1 of the invention in an operating mode of the heating oven 20 between the non-heated mode and the heated mode, in a side cross-sectional view.

Compared to the device shown in FIG. 2, a slight thermal expansion may be recognized in this figure. The expansion may particularly be directed in a radial direction (e.g. to the left and right in the figure). Both, the oven component 21 and the oven holder 31 have undergone a slight thermal expansion. It can also be seen that the heating oven 20 has undergone a slight thermal expansion. Still, there remains a gap between the surface or surfaces 22 of the oven component 21 and the surface or surfaces 31 of the oven holder 30 which form the fixed connection when the heating oven 20 is operated in the heated mode.

FIG. 2b shows a heating unit 10 for an aerosol-generating article 1 according to the embodiment of FIG. 1 of the invention in a heated mode of the heating oven 20, in a side cross-sectional view.

Since the heating oven 20 is operated in the heated mode, the first material and/or the second material have a temperature of at least 40 °C, or at least 60 °C.

Compared to the device as shown in FIG. 2a, a further thermal expansion may be recognized in this figure. The thermal expansion of the oven holder 30 and the oven component 21 is such that substantially no gap exists anymore. Accordingly, the oven holder 30 may be at least partially clamped into the oven component 21. Thereby, fixed connection of the oven holder 30 and the oven component 21 is formed. It is also to be noted that a pressure force is exerted between the oven holder 30 and the oven component 21. This pressure force is sufficiently large that the heating oven 20 cannot be easily removed, i.e. without undue force and/or without damaging the heating oven 20 and/or the oven holder 30.

This fixed connection is established solely by way of physical properties underlying the materials. Accordingly, no sophisticated, expensive and/or failure-prone equipment for fixing is necessary.

Like in FIG. 2a, also the heating oven 20 has undergone a further thermal expansion.

The thermal expansion of the first material (oven component 21) and the second material (oven holder 30) is within the elastic deformation range of each of the respective materials. Particularly, no plastic deformation has occurred.

Since the oven holder 30 may clamp at least partially into the heating oven 20 (in the heated mode of the heating oven 20), the heating oven 20 is substantially sealed. For instance, no aerosols leave the heating unit 10 in an undesired manner. Accordingly, this embodiment provides for an improved sealing, whilst the bottom of the heating oven 20 can be manufactured in a simple way compared to conventional implementations.

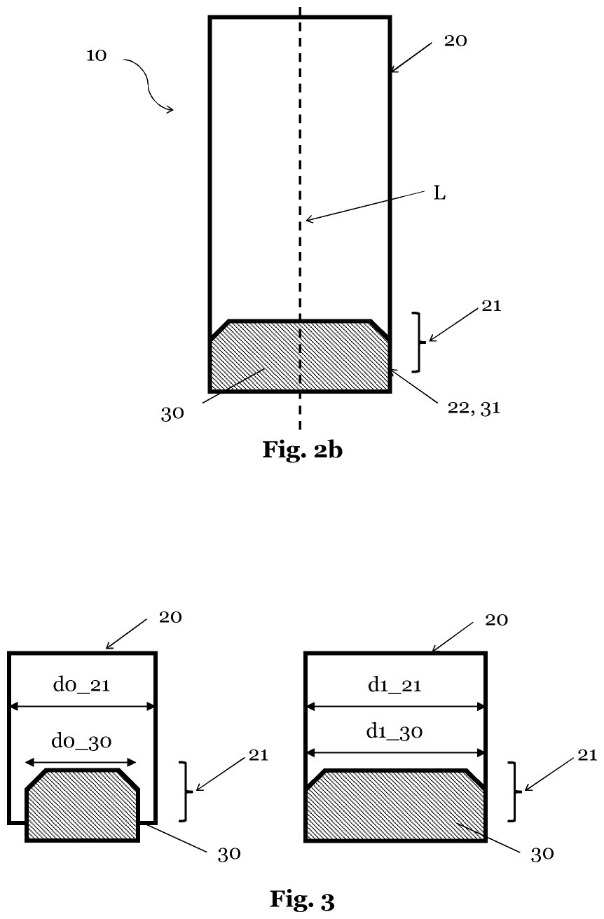

FIG. 3 shows a thermal expansion of an oven component 21 and an oven holder 30 in the non-heated mode of the heating oven 20 (left) and in the heated mode of the heating oven 20 (right) according to the embodiment of FIG. 1 of the invention, in a side cross-sectional view.

As the shapes of the oven component 21 and of the oven holder 30 are preferably cylindrical, the following example makes reference to a diameter.

The diameter of the oven component 21 in the non-heated mode of the heating oven 20 may be referred to as d0_21. It could also be referred to as an initial diameter of the oven component 21. The first material, i.e. the material of the oven component 21, has a thermal expansion coefficient expressed hereinafter as α₂₁, which is about 9.4 μm/(m K).

The diameter of the oven holder 30 in the non-heated mode of the heating oven 20 may be referred to as d0_30. It could also be referred to as an initial diameter of the oven holder 30. The second material, i.e. the material of the oven holder 30, has a thermal expansion coefficient expressed hereinafter as α₃₀, which is about 23 μm/(m K).

Assuming that the oven component 21 and the oven holder 30 are subjected to a temperature change of about 50 °C (e.g. the temperature difference from the non-heated mode to the heated mode), the corresponding diameter d1_21 of the oven component 21 in the heated mode of the heating oven 20 and the corresponding diameter d1_30 of the oven holder 30 in the heated mode of the heating oven 20 are as follows:

$${d}_{1 \_ 21} = {d}_{0 \_ 21} \cdot ( 50 K \cdot 9.4 \frac{µm}{m \cdot K} + 1 ) \qquad ( 2 )$$

$${d}_{1 \_ 30} = {d}_{0 \_ 30} \cdot ( 50 K \cdot 23 \frac{µm}{m \cdot K} + 1 ) \qquad ( 3 )$$

Evaluating the above equations (2) and (3) for the requirement that d1_21 equals d1_30, which would be desired to achieve a fixed connection for the threshold temperature of 50 °C, leads to the following table. In said table different initial diameters d0_21 of the oven component 21 are shown along with the expanded diameter d1_21 at a threshold temperature of 50° and (as another example) at a temperature of 70 °C. Furthermore, the corresponding required initial diameters d0_30 of the oven holder 30 for the threshold temperature of 50 °C and (as another example) of 70 °C are shown.

TABLE 1
Diameter of the oven component 21 in the non-heated mode
(d0_21); diameter of the oven component 21 in the heated mode
for 50 °C and 70 °C (d1_21); diameter of the oven holder
30 in the corresponding non-heated mode (d0_30)

| | d1_21 [mm] | d1_21 [mm] | d0_30 [mm] | d0_30 [mm] |
|---|---|---|---|---|
| d0_21 [mm] | @50 °C | @70 °C | @50 °C | @70 °C |
| 3.00 | 4.41 | 4.97 | 2.05 | 1.91 |
| 3.50 | 5.15 | 5.80 | 2.39 | 2.22 |
| 4.00 | 5.88 | 6.63 | 2.73 | 2.54 |
| 4.50 | 6.62 | 7.46 | 3.08 | 2.86 |
| 5.00 | 7.35 | 8.29 | 3.42 | 3.18 |
| 5.50 | 8.09 | 9.12 | 3.76 | 3.49 |
| 6.00 | 8.82 | 9.95 | 4.10 | 3.81 |
| 6.50 | 9.56 | 10.78 | 4.44 | 4.13 |
| 7.00 | 10.29 | 11.61 | 4.79 | 4.45 |
| 7.50 | 11.03 | 12.44 | 5.13 | 4.76 |
| 8.00 | 11.76 | 13.26 | 5.47 | 5.08 |
| 8.50 | 12.50 | 14.09 | 5.81 | 5.40 |
| 9.00 | 13.23 | 14.92 | 6.15 | 5.72 |
| 9.50 | 13.97 | 15.75 | 6.50 | 6.03 |
| 10.00 | 14.70 | 16.58 | 6.84 | 6.35 |

Preferably, the diameter of the oven component 21 in the non-heating mode (d0_21) is in the range of about 5 mm to 10 mm, more preferably about 6 mm to 9 mm, most preferably about 7 mm to 8.5 mm.

It can be seen that, if a greater threshold temperature (e.g. 70 °C) is desired, the initial diameter d0_30 of the oven holder 30 is relatively smaller compared to the initial diameter d0_21 of the oven component 21 as opposed to the case that a smaller threshold temperature (e.g. 50 °C) is desired.

The above table merely serves the purpose of illustrating an embodiment of the invention. It may also be possible to select the thermal expansion coefficients depending on a desired initial diameter.

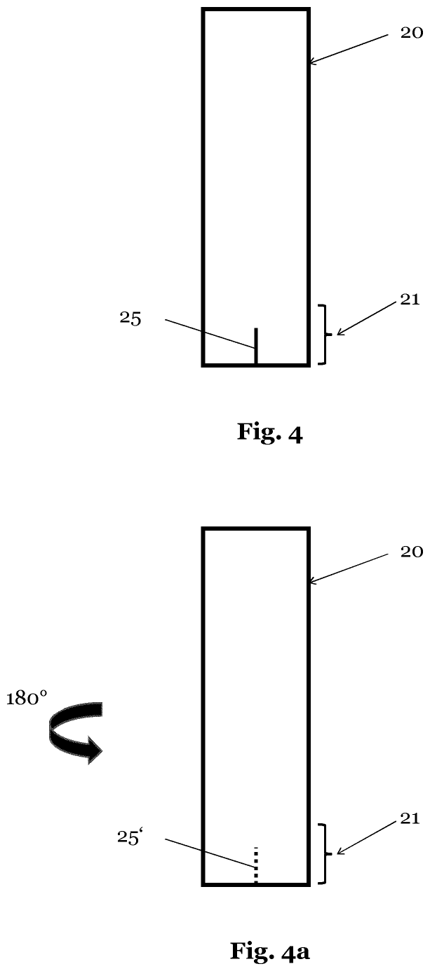

FIG. 4 shows an oven component 21 comprising a slit 25 according to an embodiment of the invention, in a first side cross-sectional view.

The slit 25 is arranged at a back end of the heating oven 20 facing away from a front end of the heating oven 20 at which an aerosol-generating article 1 (not shown in here) can be received. In this figure, the back end of the heating oven 20 is located at a bottom region of this figure.

FIG. 4a shows the embodiment of FIG. 4 in a second side cross sectional view, that is rotated by 180° compared to the first side cross-sectional view. The rotation by 180° is indicated in this figure by a respective arrow on the left-hand side.

It can be seen that the oven component 21 comprises a second slit 25′, which is optional and thereby indicated in a dotted line.

In case two slits 25, 25′ are comprised by the oven component 21, they are provided on diametral sides of the oven component 21. These two slits 25, 25′ could be manufactured with a thin wire, e.g. with a diameter of 0.05 mm-0.2 mm, such as 0.1 mm. It may also be possible to manufacture one slit 25 with water jet (only on one side). A water jet may be understood as a water jet cutter, which could be an industrial tool capable of cutting materials preferably by using a high-pressure jet of water, or a mixture of water and an abrasive substance. It is to be noted that already one slit 25 sufficiently improves the elasticity of the oven component 21.

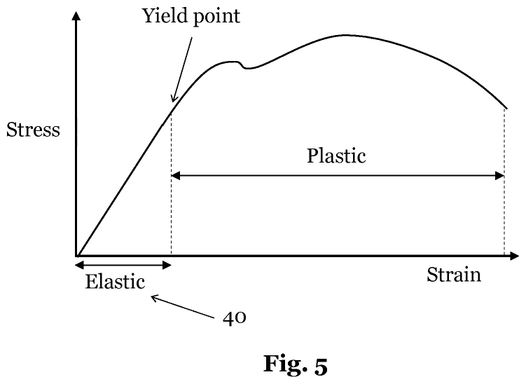

FIG. 5 shows a schematic diagram of a stress-strain curve. The relationship of stress (y-axis) and strain (x-axis) of an exemplary material is thus shown. The shape of this curve is dependent on properties of the material. The elastic deformation range 40 is indicated in this figure. It is appreciated that the thermal expansions described herein are within said elastic deformation range 40. This elastic (and linear) relationship for a material may also be known as Young's modulus.

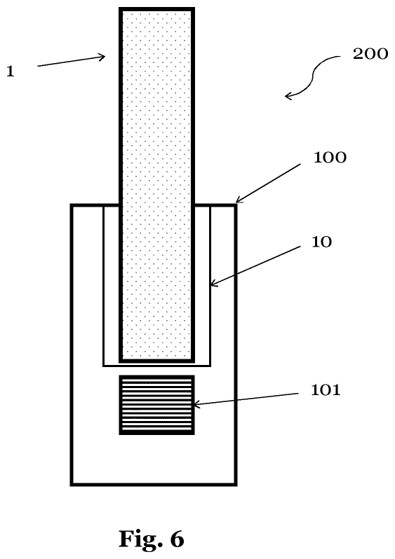

FIG. 6 shows an aerosol-generating device 100 and an aerosol-generating system 200 according to an embodiment of the invention. The system 200 comprises an aerosol-generating device 100 and an aerosol-generating article 1 comprising an aerosol-forming substrate.

The aerosol-generating device 100 comprises a heating unit 10 according to any one of the previously described embodiments. Furthermore, the aerosol-generating device 100 comprises a power supply 101 configured to provide a current to the heating unit 10, preferably to the heating oven 20, for generating an aerosol to be inhaled by a user. The power supply 101 can be any suitable power supply 101, for example a DC voltage source.

In all of the above-mentioned embodiments, the heating unit 10 is a portable or handheld heating unit 10. The same applies to the aerosol-generating device 100, the aerosol-generating system 200 and the aerosol-generating article 1.

It will be apparent to those skilled in the art that numerous modifications and variations of the described examples and embodiments are possible in light of the above teaching. The disclosed examples and embodiments are presented for purposes of illustration only. Other embodiments may include some or all of the features disclosed herein. Therefore, it is the intent to cover all such modifications and alternate embodiments as may come within the true scope of this invention.

### LIST OF REFERENCE SIGNS

1 aerosol-generating article
10 heating unit
20 heating oven
21 oven component
22 surface(s) of the oven component
25,25′ slit
30 oven holder
31 surface(s) of the oven holder
35 gap
40 elastic deformation range
80 screw
100 aerosol-generating device
101 power supply
200 aerosol-generating system
L Longitudinal axis of the heating oven

1. A heating unit for an aerosol-generating article, the heating unit comprising:
a heating oven comprising an oven component, the heating oven configured to be operated in at least a heated mode to heat an aerosol-forming substrate of an aerosol-generating article when received within the heating oven, and a non-heated mode; and
an oven holder configured to be heated when the heating oven is operated in the heated mode;
wherein the oven holder is configured to form a fixed connection with the oven component when the heating oven is operated in the heated mode, and further configured to release the fixed connection with the oven component when the heating oven is operated in the non-heated mode.

2. The heating unit according to claim 1, wherein the oven holder is configured to be clamped at least partially into the oven component to form the fixed connection, and further configured to not be clamped into the oven component for releasing the fixed connection.

3. The heating unit according to claim 1, wherein the oven component comprises a first material and the oven holder comprises a second material, wherein the thermal expansion of the second material is greater than the thermal expansion of the first material.

4. The heating unit according to claim 3, wherein the thermal expansion of the first material is within the elastic deformation range of the first material and/or wherein the thermal expansion of the second material is within the elastic deformation range of the second material.

5. The heating unit according to claim 3, wherein the first material has a thermal expansion coefficient of at most 15.0 μm/(m K) and/or of at least 6.0 μm/(m K);
and/or wherein the second material has a thermal expansion coefficient of at least 15.0 μm/(m K) and/or of at most 30.0 μm/(m K).

6. The heating unit according to claim 3, wherein, when the heating oven is operated in the heated mode, the first material and/or the second material have a temperature of at least 40 °C, where an ambient temperature is 25 °C.

7. The heating unit according to claim 3, wherein, when the heating oven is operated in the non-heated mode, the first material and/or the second material have a temperature of at most 60 °C, where an ambient temperature is 25 °C.

8. The heating unit according to claim 1, wherein, when the heating oven is operated in the non-heated mode, a gap is formed between a surface or surfaces of the oven component and a surface or surfaces of the oven holder which form the fixed connection when the heating oven is operated in the heated mode.

9. The heating unit according to claim 8, wherein the gap is on average at least 0.001 mm and/or at most 0.5 mm.

10. The heating unit according to claim 1, wherein the oven holder extends into the oven component by at least 5% and/or at most 35% of a length of the heating oven.

11. The heating unit according to claim 1, wherein the oven component is arranged at a back end of the heating oven, located opposite a front end of the heating oven through which an aerosol-generating article can be received,
wherein the oven holder extends into an end of the oven component located opposite the front end of the heating oven.

12. The heating unit according to claim 1, wherein the oven component comprises a slit at a back end of the heating oven facing away from a front end of the heating oven at which an aerosol-generating article can be received.

13. The heating unit according to claim 1, wherein the oven component is integrally formed with a cylinder comprised by the heating oven for receiving the aerosol-generating article.

14. The heating unit according to claim 1, wherein the oven component is not fixed to the oven holder by an adhesive.

15. An aerosol-generating device comprising:
the heating unit according to claim 1; and
a power supply configured to provide current to the heating unit for generating an aerosol to be inhaled by a user.
